(19) United States
(12) Patent Application Publication
(10) Pub. No.: US 2005/0087604 A1
(43) Pub. Date: Apr. 28, 2005

(54) Licensing and identification devices having coded marks and methods of making and authenticating such licensing and identification devices

(76) Inventors: Cam Van Nguyen, Brooklyn Park, MN (US); Huimin Sun, Northfield, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/972,942

(22) Filed: Oct. 25, 2004

Related U.S. Application Data
(60) Provisional application No. 60/514,809, filed on Oct. 27, 2003.
(60) Provisional application No. 60/613,969, filed on Sep. 28, 2004.
(60) Provisional application No. 60/514,808, filed on Oct. 27, 2003.

(51) Int. Cl. G06K 19/00; G06K 5/00

(52) U.S. Cl. 235/487; 235/380

(57) ABSTRACT

The present invention provides licensing and identification devices such as secure documents. Such licensing and identification devices can be produced so that there is a record of production and so that the documents cannot be produced from stolen or unauthorized materials or used by anyone other than an authorized individual or organization. A secure licensing and identification device in accordance with the present invention preferably includes a uniquely identifiable coded authorization mark and a uniquely identifiable coded information mark. The authorization mark preferably functions as a key that allows the information mark to be provided on the instrument. As such the information mark is preferably based on the authorization mark so that the information mark and the authorization mark can be used to authenticate the secure instrument.

This application claims the benefit of U.S. Provisional Application Ser. No. 60/514,809, filed Oct. 27, 2003, entitled “SECURE INSTRUMENTS AND METHODS,” and U.S. Provisional Application Ser. No. 60/613,969, filed Sep. 28, 2004, entitled “LAMINATED CARDS AND METHODS OF MANUFACTURE,” and U.S. Provisional Application Ser. No. 60/514,808, filed Oct. 27, 2003, entitled “LAMINATED CARDS AND METHODS OF MANUFACTURE,” which applications are incorporated herein by reference in their entirety for all purposes.

### TECHNICAL FIELD

The present invention generally relates to security methods that can be used with licensing and identification devices and the like. More particularly, the present invention is directed to security methods that include the use of one or more coded marks.

### BACKGROUND

Many entities such as governmental authorities, businesses, and the like have many needs for licensing and identification devices and production and control of such licensing and identification devices. Some areas where such licensing and identification devices are used include vehicle licensing, vehicle registration and ownership, payment recording, weapons licensing, trade or professional practice licensing, personal identification and certification, birth recording and certification, as well as many others. Such licensing and identification devices may take the form of license plates, vehicle titles, driver licenses, receipts, weapons permits, work licenses, identification cards, and birth certificates. Issuers and users of such licensing and identification devices desire to monitor such devices and their production in order to prevent activities such as tampering, counterfeiting, illegal production, and forgery, for example. Control over manufacturing and issuing such devices can become much more difficult when manufacturing and issuing functions are spread across many locations rather than being centralized.

License plates, as an example, are typically produced using several different methods. The production method used most commonly is to emboss characters on metal blanks that have been die cut to a desired license plate shape that is made from painted aluminum or other metals. Another method includes using metal with a reflective sheeting that has painted or rolled coat colorants on the raised portion of the embossed area to contrast characters from the background. Production of license plates can be done at one location in a jurisdiction or many locations. The license plates can be issued to the vehicle owner by various means, which may include mailing the plates to a vehicle owner, shipment to Department of Motor Vehicle (DMV) offices for issuance at a DMV office, or production and issuance at the DMV itself.

Governmental authorities or other entities or organizations sometimes also want information on a license plate that relates directly to the vehicle and an owner of the vehicle. Such information may include the vehicle identification number (VIN), the vehicle classification such as for a taxi, rental car, or commercial vehicle, owner information such as for a handicapped driver or the make, model, and/or color of the vehicle. This Governmental information can make identifying a specific vehicle easier because the license plate information can be visually matched with the vehicle or owner. Putting information on the license plate that directly relates to the vehicle or the vehicle owner can take considerable time if done at a centralized location or issuing site. By producing and/or issuing plates at distributed locations, instead of a centralized location, plates can be produced taking into account particular individual information and issued quickly. However, security is generally more difficult when providing stock materials and production systems to multiple production and issuing locations as compared to a single centralized location. The same is true, in general, for any licensing and identification devices, documents, and/or devices.

License plates, driver licenses, and other licensing and identification devices typically include security features because fraudulent use of such devices can cause loss of revenue or control for the area of coverage of a particular device. False license plates are sometimes used by those who do not want to pay registration taxes, have a poor driving record, or want to use the vehicle in commission of a crime or other offense. A fake driver license might be used for cashing bad checks or obtaining alcoholic beverages or other age restricted products. Fake identification cards might be used to obtain social benefits where there is no entitlement. In general, these activities are socially undesirable.

There are many potential weaknesses in typical secured licensing and identification devices. Where the device has few security features, a forger might be able to more easily make a fake version that would pass for the legal version. For example, a forger might be able to take an original driver license and alter the driver license with a new identity or change other information such as a birth date or the like. Also, operators of processing systems used to make secure licensing and identification devices might be able to make and illegally sell legal versions of such a secure device where there is little or no secured control of production. Secure materials used to make such secure devices could potentially be stolen and used by counterfeiters to make illegal versions of the secure device.

Customer service is a high priority for those that make, issue, and use secure licensing and identification devices. When such secure devices are produced at a central location, and applied for and issued at a different location, the customer must go to a specified location and apply for the secure device and then wait for the secure device to be produced. Quite often a secure device such as a driver license or license plate with vehicle specific information may take days, weeks, or even months for production and delivery. In some cases an individual may need to make two or more visits to a particular location to apply and then later pickup a previously applied for licensing and identification device. This can be burdensome for many customers. One solution would be to produce the secure licensing and identification device at the same location where a customer applies for the secure licensing and identification device for immediate delivery. This method of distributed production might allow for more unauthorized licensing and identification device to be made because there might be more people involved in production. The materials (often secure themselves) to make the licensing and identification devices would be present at more locations and might be easier to steal.

Systems that produce secure licensing and identification devices are often complex and expensive to acquire. Moreover, the materials used to make such licensing and identification devices are generally expensive. This is caused by an assumption that system and material complexity is one way to stop the fraudulent production of secure licensing and identification devices. Additionally, complexity is not only more expensive but the maintenance of the system can be greater.

### SUMMARY

The present invention provides licensing and identification devices such as secure driver licenses and vehicle license plates that are protected against being forged, altered, or produced without permission or knowledge of an issuing authority such as a business or governmental entity, or the like. Materials used to make such licensing and identification devices can be accounted for so there is a record of production of such materials. Licensing and identification devices are therefore difficult or impossible to produce from stolen or unauthorized materials or used by anyone other than the original authorized individual or organization. Such accounting can be accomplished by using a database of information to track and control production and issuance of such licensing and identification devices.

Accordingly, licensing and identification devices such as driver licenses and vehicle license plates and other related security documents are provided by the present invention. Also, methods to secure both the driver license or license plate itself and the production activities for the driver license or license plate are provided.

A driver license or license plate in accordance with the present invention includes security features. Preferably the driver license or license plate includes visual security features, optional hidden security features, and an encrypted dot code. Such security features can be in the form of a sticker or may be directly incorporated into the driver license or license plate. A security feature in accordance with the present invention may include ways to indicate (visually, for example) when modification or disassembly of the driver license or license plate is attempted. Additional security features may be used and preferably include an image made in half tone print. Such a half tone image can be made so that it is not reproducible on a photocopier or other copying or reproducing device and may contain any desired information.

An exemplary secure licensing and identification device in accordance with the present invention preferably includes a uniquely identifiable coded authorization mark and a uniquely identifiable coded information mark provided on a surface of a licensing and identification device. For example, any of such marks may be printed on a surface of the licensing and identification device and preferably comprise a secure dot code or the like. Preferably, the coded authorization mark and the coded information mark can be cooperatively decoded to authenticate the licensing and identification device. That is, the coded authorization mark and the coded information mark are preferably read and decoded and predetermined information in the coded authorization mark is preferably compared to predetermined information in the coded information mark. When such information matches, the licensing and identification device can be authenticated. This is because the authorization mark, containing coded authentication data, is preferably provided on a blank form by an issuing authority or business before the information mark is formed. When the information mark is formed on the blank form at a later time, the authorization mark is first read and decoded to obtain the authentication data. The authentication data is then incorporated into the information mark such as when the blank form is filled out and issued as a licensing and identification device. Because proprietary software or software to which access can be controlled or restricted is preferably used to code and decode the authorization and information marks, formation of these marks can be controlled in a secure manner.

Licensing and identification devices and production techniques in accordance with the present invention can be used to provide a driver identification and license card. An exemplary driver identification and license card in accordance with the present invention preferably includes a uniquely identifiable coded authorization mark and a uniquely identifiable coded information mark each provided on a surface of the driver identification and license card. The coded authorization and information marks preferably each comprise a dot code printed on a surface of the driver identification and license card in accordance with one aspect of the present invention. The uniquely identifiable coded authorization mark preferably comprises information that can be used to authenticate the identification and license card such as a code or the like that can be compared to a database that identifies authentic codes. The uniquely identifiable coded information mark preferably comprises information related to a driver to which the card is issued. In accordance with the present invention, the coded authorization mark and the coded information mark can be cooperatively decoded to authenticate the driver identification and license card as described above.

Licensing and identification devices and production techniques in accordance with the present invention can also be used to provide a vehicle identification and registration plate that is issuable to a vehicle. An exemplary vehicle identification and registration plate in accordance with the present invention preferably includes a uniquely identifiable coded authorization mark and a uniquely identifiable coded information mark provided on a surface of the vehicle identification and registration plate. The coded authorization and information marks each preferably comprise a dot code printed on a surface of the driver identification and license card in accordance with one aspect of the present invention. The uniquely identifiable coded information mark preferably comprises information related to a driver and vehicle to which the vehicle identification and registration plate is issued. In accordance with the present invention, the coded authorization mark and the coded information mark can be cooperatively decoded to authenticate the vehicle identification and registration plate.

Methods of making such licensing and identification devices are also provided in accordance with the present invention. One exemplary method comprises the steps of providing a uniquely identifiable coded authorization mark on a surface of an instrument, decoding the uniquely identifiable coded authorization mark, and providing a uniquely identifiable coded information mark that is based at least in part on information from the decoded authorization mark on a surface of the instrument. For example, blank driver license forms can be created wherein each form includes a uniquely identifiable coded authorization mark. Preferably, a coded authorization mark is designed so that it can establish authentic starting materials. When an individual license is to be issued to a driver, the blank form can be completed with specific information out and the coded authorization mark can be read and decoded by the issuing authority. Information related to the individual driver as well as information contained in the coded authorization mark can then be used provide the coded information mark.

Methods of authenticating such licensing and identification devices are also provided in accordance with the present invention. One exemplary method comprises providing a licensing and identification device having a uniquely identifiable coded information mark that is at least partially based on information contained in a uniquely identifiable coded authorization mark. The secure instrument can be authenticated by cooperatively decoding the authorization mark and the information mark to verify that the coded information mark is properly based on the authorization mark.

In other aspects of the present invention, additional security features may be used with such coded authorization and information marks. For example, a hologram or the like may be used. Moreover, such additional security features may be provided as a label or sticker. Preferably, such a label or sticker is highly visible with easy to recognize security features. The security method should not be generally available for common use and is preferably individualized to the particular entity using the security feature. Such a label or sticker can be shaped with complex patterns to make unauthorized duplication more difficult and tampering more evident.

The present invention provides many advantages. For example, software and/or algorithms that can be used to form coded authorization marks and coded identification marks in accordance with the present invention can be controlled and restricted from the public domain. This can prevent common usage of such software or algorithms and generally increases the security of such coded marks. Also, commercially available printers can be controlled so that they are not capable of printing such controlled codes. An authorization dot code of the present invention can be printed with 3×3 dots per cell (600 dots per inch) thus providing codes with generally small dimensions. Such small codes cannot be duplicated in current copying machines and still be readable for decoding. A coded authorization mark in accordance with the present invention can be encrypted (with 128-bit encryption, for example) in order to prevent unauthorized use or duplication of the code even if the print algorithm for the code were obtained. A coded authorization mark can use printable and non-printable characters to further add complexity.

The present invention provides advantages related to security of production of a licensing and identification device as well as security of the devices themselves. Licensing and identification devices with a coded authorization mark and a coded information mark of the present invention and/or additional security features would be difficult to copy, forge, or otherwise reproduce in any manner that would not be detectable by visual and electronic code reading. For example, a potential forger would not be able take an original licensing and identification device and alter the device to include new information. This is because information, such as a name, address, birth date, photograph, or the like, can be provided in clear view on the face of the device. The same information can also be provided in the coded information mark. Even if any visible information could be altered to contain new information, the new information would not match that in the coded information mark.

The present invention provides other advantages related to securing materials, such as secure papers and the like, that are used to form licensing and identification devices. There is the possibility that such secure materials could be stolen and used by counterfeiters to make illegal versions of a licensing and identification device. The present invention renders stolen unprinted secure paper useless because an unauthorized user cannot print a coded authorization mark on such paper because proprietary software and/or algorithms are preferably used to provide such a coded mark. Likewise, if paper that already includes an authentic coded authorization mark is stolen, such stolen paper can be later identified because each coded authorization mark is uniquely identifiable and can thus be accounted for. Once paper with a particular coded authorization mark is lost or stolen, the coded authorization mark associated with that paper can be removed from a database of authentic marks, for example. For example, if someone were to take stolen paper with a coded authorization mark to an issuing authority to have such paper issued as a driver license or the like, such a database could be accessed to verify the authenticity of the coded authorization mark.

### BRIEF DESCRIPTION OF THE DRAWINGS

FIG. 1 is an exemplary driver identification and license card including security features in accordance with the present invention; and

FIG. 2 is an exemplary vehicle identification and license plate including security features in accordance with the present invention.

### DESCRIPTION

The present invention provides security methods for use with licensing and identification devices such as driver licenses and vehicle identification plates. Such security methods, in accordance with the present invention, can be used to provide security as to the production and issuance of licensing and identification devices. That is, materials such as blank forms and the like can be controlled and accounted for. Security methods in accordance with the present invention can also provide security with respect to licensing and identification devices themselves. That is, such security methods can be used to verify the authenticity of a licensing and identification device or to verify the authenticity of information contained in such a licensing and identification device, or both.

Security methods in accordance with the present invention preferably use one or more uniquely identifiable coded or encrypted marks that include secure data. Techniques for securing data, such as personal data or biometric data, are known. For example, two-dimensional matrix coding technology uses so-called two-dimensional or area symbologies. An area symbology typically includes a matrix having a generally rectangular or square shape. Preferably, the coded marks utilized in accordance with the present invention comprise area symbologies. These area symbologies themselves are well known, such as are described in U.S. Pat. No. 5,612,524, U.S. Pat. No. 5,331,176, U.S. Pat. No. 4,972,475, and U.S. Pat. No. 4,924,078, the entire disclosures of which are incorporated herein by reference for all purposes. Such area symbologies are commercially known under the tradenames Vericode™ or Data Matrix™ or Code One™. Typically, in these techniques, information is encoded by an appropriate technique such as by encoding the information into Reed-Solomon blocks. A data matrix that contains a plurality of data cells is then generated from the encoded information. Next, the data matrix is converted to a bitmap image, in the form of a symbol, and the image is printed on an object.

One security method in accordance with the present invention uses a uniquely identifiable coded mark to provide a security feature on a blank document, form, or other such material for forming a secure licensing and identifying device. Such a mark is preferably used to authenticate the validity of such a document or to authorize using the document to form a licensing and identifying device in accordance with the present invention as described below. That is, because access to the algorithm for coding and decoding such a mark can be secured and controlled, such a mark can be coded with information that can be used to authenticate the mark when decoded. For example, proprietary software and/or algorithms can be used and can be controlled in a secure manner. Moreover, such a mark can be used to account for a batch of licensing and identifying devices because each licensing and identifying device can contain an individual unique coded mark. Generally such a mark is referred to as a uniquely identifiably coded authorization mark herein.

A uniquely identifiable coded authorization mark in accordance with the present invention can also be used together with another distinct uniquely identifiable coded mark as a security feature. A coded authorization mark can be decoded and information contained in the authorization mark, preferably along with additional information, can be used to form a second uniquely identifiable coded mark. Such additional information preferably includes information specific to a recipient of the licensing and identifying device such as personal or biometric information or the like as described in more detail below. As such, the second coded mark is generally referred to as a uniquely identifiably coded information mark herein. In this way, a coded information mark can incorporate information contained in a coded authorization mark so that the coded authorization mark and the coded information mark can be cooperatively decoded in order to verify that the coded information mark and/or information contained in the coded information mark is authentic. Such verification is based on the fact that one must be able to read and decode the authorization mark in order to form a valid information mark. This makes it nearly impossible to form a valid coded information mark (or to alter the information contained in the coded information mark) without being able to read the coded authorization mark. Because software and/or algorithms used for making such coded marks is preferably controlled or kept secret, only an authorized user can read, decode, and form a coded mark in accordance with the present invention.

A uniquely identifiable coded authorization mark can be used to individually number and securely label document materials (secure paper, for example) or blank documents (forms, for example) before distribution to a document production or issuing site. Preferably, information in the coded mark uniquely identifies each document material or blank document and functions as an authorization mark for authorizing further processing of the document as described below. Preferably, such an authorization code is provided as a coded authorization mark that is provided on a surface of the document material and ultimately on the licensing and identifying device. A coded authorization mark can be combined with highly visible security labeling such as holograms as well as other security markings to provide a complex combination of security features that provide differing levels of protection.

A coded authorization mark can be used as a secure input for document printing software in accordance with the present invention. Software can be designed so that each individual print job (such as for printing a license or the like) preferably requires the authorization mark to be decoded and read for the document to be printed. A document production or issuing site is preferably issued a known group of documents, each having a coded authorization mark issued by a controlling business or authority, for example. Each of these coded authorization marks can be entered into the computer software. The printing software is preferably designed so that it will recognize only documents from the input batch. As such, an unauthorized document (having an unknown authorization mark) cannot be printed. The software is preferably also configured so that it will only allow an individual authorization mark to be used one time.

Such software preferably uses the coded authorization mark as a security key to print an additional coded mark (a uniquely identifiable coded information mark) that is based on the coded authorization mark. Preferably, the information mark incorporates information from the coded authorization mark as well as additional information. Such additional information may specifically identify the recipient of the document and may also include any other desired information. For example, such information content may include personal information about a licensee owner such as name, address, height, weight, age, birthday, hair and eye color, insurance policy number and the like. Additional information may be related to a vehicle and may include make, model, color, VIN, number of doors, weight, engine size, fuel type and the like. The coded information mark can also contain biometric data to further identify the document recipient. The biometric data may be an electronically coded finger print identification, face feature identification, eye feature identification, face image, electronic signature identification or other means to specifically identify an individual person. The coded information mark could also have an electronically coded image of the article such as the vehicle image. In one aspect of the present invention, all of the information that is printed and visible on the face of the licensing and identifying device can also be provided in the coded information mark. That way, the printed information and coded information must match and a comparison of the two can detect whether the printed information has been altered.

Coding of data to form such a coded mark can be done by any desired technique and is preferably done by an electronic or computer based technique. For example, data to be encoded can be converted to a binary stream of ones and zeros. The binary information can then be further encrypted to allow Error Detection And Correction (EDAC). This encrypted binary stream can then be distributed to a 2-dimensional symbology such as a matrix array that can be contained in the dot code. Any linear or stacked area, or other symbology can be used. An area symbology (or dot code,) as used herein, refers to any symbology, such as those commercially known under the trade names VeriCode™ or VSCode™ or Data Matrix™ or Code One™ or the like, that employs a matrix of data cells, rather than one or more rows of bars and spaces. Area symbologies as well as techniques for electronically coding data are well known, such as are described in U.S. Pat. No. 5,612,524, U.S. Pat. No. 4,924,078, and European Patent No. 0438841, the entire disclosures of which are incorporated herein by reference for all purposes.

By reading and decoding the coded authorization mark together with the coded information mark, the authenticity of the information mark can be verified. This is because the coded information mark is based on coded authorization mark and preferably incorporates information or data found in the authorization mark into the coded information mark. As such, the authenticity of a secure instrument and the information contained in the coded information mark can be verified. The coded authorization mark is preferably organized and encrypted to allow only those with certain permission levels to view certain portions of the code-contained data.

Any of the data contained in the coded information mark can be provided on a secure document in visual form. As an example, a face image of the document recipient can be provided on a secure document so that the image can be visually matched with an electronic image on the code readers computer monitor. That is, decoding the information code can provide data to create the electronic image for comparison. To further add security, any portion of the coded information mark data could be printed in a single or multiple half tone or light colored image. This half tone or light colored image could be for example a vehicle license plate number, VIN, face image, or other biometrical data. The half tone or light colored image could be printed under the normal data printed on the document. Half tone or light colored images are hard to duplicate in a copying machine and difficult to reproduce by a forger or counterfeiter.

Preferably a database is used to manage information contained in the coded authorization mark and the coded information mark. The information in the database could be uploaded to a computer database as a means of continuously monitoring and controlling a document production site. Because every document with the coded authorization mark can be configured to require accountability, any use for illegal activity can quickly become apparent. The database of information could be further used in identifying the document recipient and any article ownership without use of the secured document.

The present invention can be used in conjunction with systems that have a secure means of obtaining and processing data. False data that is placed on a secure document is still false data. By connecting the system software to a control computer (such as a server or other computer at a controlling authority or business or the like), the system software can be used to verify predetermined document recipient and article ownership information and to receive permission for document production. The direct interface of application software and the control computer is one method of assuring the quality of downloaded data from the control computer and the timeliness of information uploaded to the control computer. However, a control computer does not need to be connected to software at a document production site. For example, the control computer may not be capable of the increased activity or the owner of the control computer may not want a direct connection of the control computer to outside locations.

The present invention provides features that can improve data security without a direct connection to a control computer. A coded mark can be used to physically transfer data in a secure manner instead of electronically. An encrypted or coded mark could be printed by a control computer and sent or given to a document recipient. This means of conveyance would be more likely to produce good data transfer with secure information as compared to hand written or printed data transfer. An example of this type of data security would be sending a driver a driver license renewal application with a coded mark via mail. Preferably, the document production site would have the means to verify that the person with the coded mark document is entitled to that document. It should be noted that once a person has received a document made in accordance with the present invention and that the facial image, biometric data such as a fingerprint, and other securing data such as an electronic copy of a signature are in the database, all further generation of data could contain the noted personal identity means for personal identification.

A document recipient can go to a document production site and apply for a secure document such as a licensing and identifying device. A secure document can be issued to the recipient with a uniquely identifiable coded authorization mark such as by mail or the like. The secure document with the coded authorization mark can then be taken to the document production site. The document production site printer operator can read the coded authorization mark on the secure document, place the document in the printer, print the document with a coded information mark and do post work on the document such as lamination of a top film or die cutting if required.

Security features such as authorization and identification codes can be printed in any manner. These codes can be printed with any desired inks such as security inks including Magnetic, UV-Invisible Long Wave, UV-Invisible Short Wave, Dual Band, UV-Invisible, Laser Invisible, IR Visible to Invisible, IR Absorption, Holographic, Invisible UV Latent Reaction, Single Quadrant Color Shifting, Double Quadrant Color Shifting, Multi Quadrant Color Shifting, Micro Tracer, Visible/Invisible, Thermochromatic, Photochromatic, UV Blocker, Taggent Security, pH Indicator, Chemical Reactive, Dry Offset Raised Image UV, and/or High Brightness Metallic.

Licensing and identification devices, such as driver licenses and the like may be made as disclosed in co-pending U.S. Provisional Application entitled “LAMINATED CARDS AND METHODS OF MANUFACTURE,” Attorney Docket No. VER0013/P1, to Huimin Sunn et al. and filed on the same date as the subject application, the entire contents of which are fully incorporated herein by reference for all purposes.

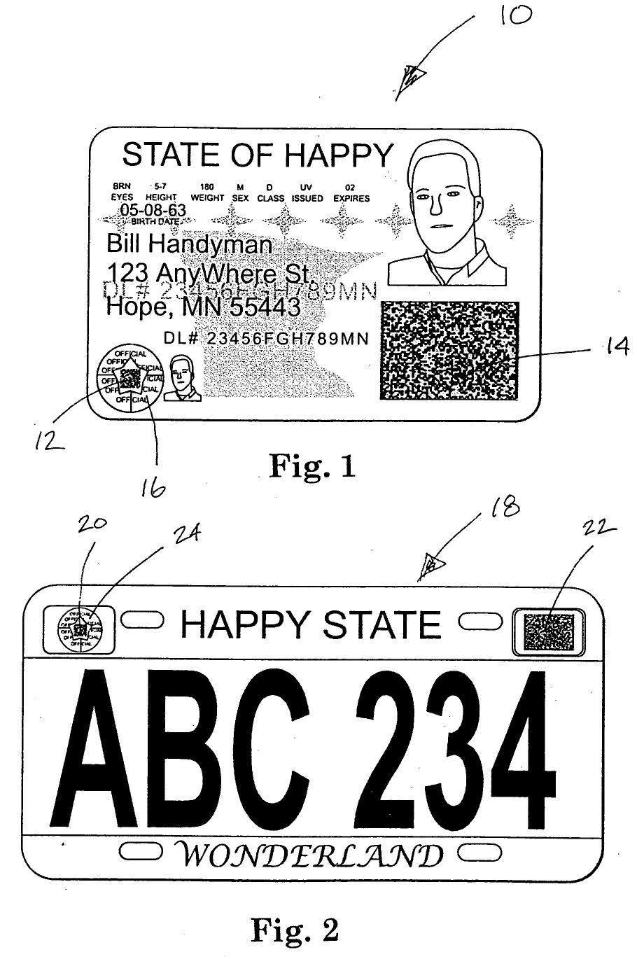

FIG. 1 shows an exemplary driver identification and license card 10 that includes security features in accordance with the present invention. As illustrated, the driver identification and license card includes a coded authorization mark 12 provided in a lower left-hand corner of the card and a coded information mark 14 provided in the lower right hand corner of the card 10. As shown, the coded authorization mark 12 is positioned within an open portion of an optional additional security feature in the form of a secure hologram 16. The coded information mark 14 may include any information desired such as driver identification information and/or other data related to the driver. For example, if desired, the coded information mark 14 may comprise information related to a fingerprint or any other biometrical data.

As shown, the driver identification and license card 10 may include other optional security features. For example, the driver identification and license card can include security features such as symbols or images or the like that are printed in half tone or a light color or gray. Other security marks that can be used include angular color shifting marks and the like. In any case, a security feature that is difficult to reproduce, such as by photocopying, is preferably used. If desired, other information such as a driver address, photograph, state seal, or the like may be included.

Referring to FIG. 2, exemplary secure license plate 18 in accordance with the present invention is shown. As illustrated, the license plate 18 includes coded authorization mark 20 provided in an upper left-hand corner of the license plate 18 and a coded information mark 22 provided in the upper right hand corner of the license plate 18. As shown, the coded authorization mark 20 is positioned within an open portion of an optional additional security feature in the form of a secure hologram 24. The authorization 20 and/or information mark 22 may include any desired information such as vehicle, owner, and/or registration information and the like.

1. A secure card, the secure card comprising:
a uniquely identifiable coded authorization mark provided on a surface of the secure card; and
a uniquely identifiable coded information mark provided on a surface of the secure card;
wherein the coded authorization mark and the coded information mark can be decoded to authenticate the secure card.

2. The secure card of claim 1, wherein at least one of the coded authorization mark and the coded information mark comprises a two-dimensional symbol.

3. The secure card of claim 2, wherein the two-dimensional matrix comprises a dot code.

4. The secure card of claim 1, wherein the coded authorization mark comprises information that can be used to verify the source of the secure card.

5. A driver identification and license card, the driver identification and license card comprising:
a uniquely identifiable coded information mark provided on a surface of the card comprising information related to a driver to which the card is issued; and
a uniquely identifiable coded authorization mark provided on a surface of the card;
wherein the coded information mark and the coded authorization mark can be decoded to authenticate the driver identification and license card.

6. The driver identification and license card of claim 5, wherein at least one of the coded authorization mark and the coded information mark comprises a two-dimensional symbol.

7. The secure instrument of claim 6, wherein the two-dimensional symbol comprises a dot code.

8. A vehicle identification and registration plate issuable to a vehicle, the vehicle identification and registration plate comprising:
a uniquely identifiable coded information mark provided on a surface of the vehicle identification and registration plate comprising information related to a vehicle to which the plate is issued; and
a uniquely identifiable coded authorization mark provided on a surface of the vehicle identification and registration plate;
wherein the coded information mark and the coded authorization mark can be decoded to authenticate the vehicle identification and registration plate.

9. The vehicle identification and registration plate of claim 8, wherein at least one of the coded authorization mark and the coded information mark comprises a two-dimensional symbol.

10. The secure instrument of claim 9, wherein the two-dimensional symbol comprises a dot code.

11. A method of making a secure card, the method comprising the steps of:
providing a card having a uniquely identifiable coded authorization mark on a surface of the card;
decoding the uniquely identifiable coded authorization mark; and
providing a uniquely identifiable coded information mark based on information from the decoded authorization mark on a surface of the card.

12. The method of claim 11, wherein at least one of the coded authorization mark and the coded information mark comprises a two-dimensional symbol.

13. The method of claim 12, wherein the two-dimensional symbol comprises a dot code.

14. The method of claim 11, further comprising the step of printing the coded authorization mark on the surface of the card.

15. The method of claim 11, wherein the step of decoding the authorization mark comprises verifying the source of the card.

16. The method of claim 11, wherein the step of providing the coded information mark comprises printing the coded information mark on the surface of the card after decoding the authorization mark.

17. A method of authenticating a secure card, the method comprising the steps of:
providing a card having a uniquely identifiable coded authorization mark on a surface of the card;
decoding the uniquely identifiable coded authorization mark;
providing a uniquely identifiable coded information mark based on information from the decoded authorization mark on a surface of the card; and
authenticating the card by decoding the authorization mark and the information mark.

18. The method of claim 17, wherein at least one of the coded authorization mark and the coded information mark comprises a two-dimensional symbol.

19. The method of claim 18, wherein the two-dimensional symbol comprises a dot code.

20. The method of claim 17, further comprising the step of printing the coded authorization mark on the surface of the card.

21. The method of claim 17, wherein the step of decoding the authorization mark comprises verifying the source of the card.

22. The method of claim 17, wherein the step of providing the coded information mark comprises printing the coded information mark on the surface of the card after decoding the authorization mark.
